(19) United States
(12) Patent Application Publication
(10) Pub. No.: US 2005/0285970 A1
(43) Pub. Date: Dec. 29, 2005

(54) Optical apparatus

(75) Inventors: Shinji Yamaguchi, Osaka-shi (JP); Genta Yagyu, Nishinomiya-shi (JP)

Correspondence Address: SIDLEY AUSTIN BROWN & WOOD LLP, 717 NORTH HARWOOD, SUITE 3400, DALLAS, TX, 75201, US

(73) Assignee: KONICA MINOLTA PHOTO IMAGING, INC.

(21) Appl. No.: 10/968,455

(22) Filed: Oct. 19, 2004

(30) Foreign Application Priority Data
Jun. 29, 2004 (JP) 2004-190660

(51) Int. Cl. H04N 5/262; H04N 5/238; G03B 9/08; G03B 17/02

(52) U.S. Cl. 348/363; 348/240.3; 396/462

(57) ABSTRACT

In an optical apparatus provided with: a variable focal length lens system including a plurality of lens units and performing magnification variation by moving at least one lens unit along the optical axis; and an image sensor that converts an optical image formed by the variable focal length lens system into an electric signal, the shutter is disposed to the object side of the most image side lens unit, the aperture stop that determines the f-number is disposed separately from the shutter, and a magnification variation range where the distance between the shutter and the aperture stop varies with magnification variation is provided.

This application is based on Japanese Patent Application No. 2004-190660 filed on Jun. 29, 2004, the contents of which are hereby incorporated by reference.

### BACKGROUND OF THE INVENTION

1. Field of the Invention

The present invention relates to an optical apparatus, and more specifically, to an optical apparatus that optically captures an image of a subject by a taking lens system and outputs it as an electric signal by an image sensor, above all, an image-taking apparatus having a compact and thin variable focal length lens system (for example, a zoom lens system) and a camera (for example, a small-size digital camera) having the image-taking apparatus.

2. Description of Related Art

In recent years, digital still cameras and video cameras capable of optical zooming have been reduced in size. For this reason, image-taking apparatuses provided therein are required to be compact and thin. Moreover, demand has been rising for a compact image-taking apparatus capable of being provided in cellular phones, personal digital assistants and the like. In response to these requests, the following have been proposed: the thickness in the retracted state is reduced by a construction in which the part where the image-taking apparatus is incorporated is rotated (with respect to the camera body) between at the time of image taking and in the retracted state; and the thickness of the image-taking apparatus is reduced by bending the optical axis by disposing a prism or a mirror in the taking lens system. In the case of these image-taking apparatuses, since the size in the direction of the lens diameter largely affects the camera thickness, the reduction in the thickness in the direction of the lens diameter is greatly desired as well as the reduction in the overall optical path length. To reduce the thickness of the image-taking apparatus in the direction of the lens diameter, it is necessary to reduce the size of the first lens unit (frontmost lens unit) of the taking lens system in the direction of the lens diameter, and this enables the reduction in the camera thickness and the reduction in the area of the lens part on the appearance of the camera.

However, when the size of the first lens unit is reduced in the direction of the lens diameter in conventional taking lens systems, the off-axial beam is vignetted by the first lens unit, so that in the position of the aperture stop that determines the f-number, the off-axial beam passes through a position asymmetrical with respect to the optical axis. A shutter unit is frequently disposed in the vicinity of the aperture stop that determines the f-number, and cutting, by the shutter, the off-axial beam that is asymmetrical with respect to the optical axis is a problem. When the off-axial beam asymmetrical with respect to the optical axis is cut by high-speed shutter release, for example, by use of a single-bladed shutter, the off-axial beam is nonuniformly cut, so that the light quantity is different between both ends of the formed image. It is possible to eliminate the difference in light quantity and obtain an image with no illumination nonuniformity by cutting the off-axial beam symmetrically with respect to the optical axis by use of a plurality of shutter blades. However, a driver for moving a plurality of shutter blades is required and this increases the cost of the shutter unit. In addition, since it is necessary to secure a space for a plurality of shutter blades to retract into, the shutter unit is increased in size, so that it is difficult to reduce the thickness of the entire image-taking apparatus.

### SUMMARY OF THE INVENTION

An object of the present invention is to provide an image-taking apparatus achieving the reduction in the thickness in the direction of the lens diameter and being capable of obtaining a formed image with uniform brightness even when an inexpensive and small-size shutter unit is used.

To achieve the above-mentioned object, according to a first aspect of the invention, an optical apparatus is provided with: a lens system including a plurality of lens units for forming an image on a predetermined focal plane, wherein at least one of the lens units is movable along the optical axis, and the focal length of the lens system is varied as a result of the at least one lens unit being moved; a shutter disposed on the object side of the most image-side lens unit of the plurality of lens units; and an aperture stop for determining the f-number. Here, as the at least one lens unit moves, at least within part of the movement range thereof, the interval between the shutter and the aperture stop varies.

According to a second aspect of the invention, an optical apparatus is provided with: a lens system including a plurality of lens units for forming an image on a predetermined focal plane, wherein at least one of the lens units is movable along the optical axis, and the focal length of the lens system is varied as a result of the at least one lens unit being moved; a shutter disposed on the object side of the most image-side lens unit of the plurality of lens units; and an aperture stop for determining the f-number. Here, as the at least one lens unit moves, at least within part of the movement range thereof, the shutter moves in such a way that the shutter is located at or near the point at which the central ray of the off-axial beam that focuses at the highest image height crosses the optical axis.

According to the present invention, since a magnification variation range where the distance between the shutter and the aperture stop varies with magnification variation is provided, even if the first lens unit is small in the direction of the lens diameter, the off-axial beam can be uniformly cut by the shutter, so that the light quantity can be prevented from being different between both ends of the formed image. Consequently, the thickness of the entire image-taking apparatus can be reduced in the direction of the lens diameter, and a formed image with uniform brightness can be obtained even when an inexpensive and small-size shutter unit is used. The use of the image-taking apparatus for appliances such as digital cameras and personal digital assistants contributes to a smaller thickness, a smaller size, higher performance, higher functionality, lower cost and the like of these apparatuses.

### BRIEF DESCRIPTION OF THE DRAWINGS

FIGS. 1A to 1C are construction diagrams of a first embodiment (Example 1);

FIGS. 2A to 2C are construction diagrams of a second embodiment (Example 2);

FIGS. 3A to 3C are construction diagrams of a third embodiment (Example 3);

FIGS. 4A to 4I are aberration diagrams of Example 1;

FIGS. 5A to 5I are aberration diagrams of Example 2;

FIGS. 6A to 6I are aberration diagrams of Example 3;

FIGS. 7A and 7B are schematic views showing examples of the optical construction of an optical apparatus according to the present invention;

FIGS. 8A and 8B are schematic views for explaining an off-axial beam that passes through the aperture stop when the diameter of a first lens unit is large;

FIGS. 9A to 9C are schematic views for explaining an off-axial beam that passes through the aperture stop when the diameter of the first lens unit is small;

FIGS. 10A to 10C are schematic views showing an example of the construction of a single-bladed shutter unit;

FIGS. 11A to 11C are schematic views showing an example of the construction of a four-bladed shutter unit;

FIGS. 12A and 12B are perspective views showing a concrete example of a single-bladed shutter unit along the optical axis; and

FIGS. 13A and 13B are perspective views showing a concrete example of a two-bladed shutter unit along the optical axis.

### DETAILED DESCRIPTION OF PREFERRED EMBODIMENTS

Hereinafter, image-taking apparatuses and the like embodying the present invention will be described with reference to the drawings. The image-taking apparatus is an optical apparatus that optically takes in an image of a subject and then outputs it as an electric signal, and constitutes a principal component of cameras used for taking still images or moving images of a subject. Examples of such cameras include digital cameras; video cameras; surveillance cameras; car-mounted cameras; cameras for picturephones; cameras for doorphones; and cameras incorporated in or externally attached to personal computers, mobile computers, cellular phones, personal digital assistants (PDAs), peripherals thereof (mouses, scanners, printers, etc.) and other digital appliances. As is apparent from these example, not only a camera can be formed by using an image-taking apparatus but also a camera function can be added by providing an image-taking apparatus to various appliances. For example, a digital appliance having an image input function such as a cellular phone furnished with a camera can be formed.

Incidentally, the term “digital camera” in its conventional sense denotes one that exclusively records optical still pictures, but, now that digital still cameras and home-use digital movie cameras that can handle both still and moving pictures have been proposed, the term has come to be used to denote either type. Accordingly, in the present specification, the term “digital camera” denotes any camera that includes as its main component an image-taking apparatus provided with an image-taking lens system for forming an optical image, an image sensor for converting the optical image into an electrical signal, and other components, examples of such cameras including digital still cameras, digital movie cameras, and Web cameras (i.e., cameras that are connected, either publicly or privately, to a device connected to a network to permit exchange of images, including both those connected directly to a network and those connected to a network by way of a device, such as a personal computer, having an information processing capability).

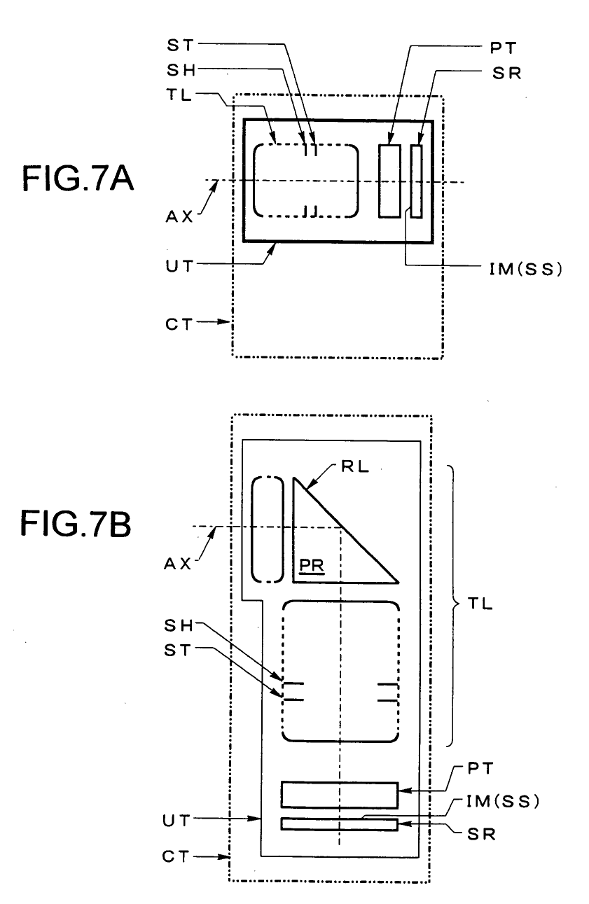

FIGS. 7A and 7B show examples of the construction of an image-taking apparatus UT. The image-taking apparatus UT shown in FIG. 7A has an optical construction of a type in which the optical path is not bent, whereas the image-taking apparatus UT shown in FIG. 7B has an optical construction of a type in which the optical path is bent. These image-taking apparatuses UT comprise from the object (that is, the subject) side: a zoom lens system (corresponding to a taking lens system, ST: a aperture stop, SH: a shutter) TL that forms an optical image (IM: image plane) of the object so as to be scalable; a plane parallel plate PT (corresponding to an optical filter such as an optical low-pass filter or an infrared cut filter as required and to the cover glass of an image sensor SR); and the image sensor SR that converts the optical image IM formed on a light receiving surface SS by the zoom lens system TL into an electric video signal, and constitute a part of a digital appliance CT corresponding to a digital camera, a portable information apparatus (that is, an information apparatus terminal that is compact and portable such as a cellular phone or a PDA). When a digital camera is formed by use of this image-taking apparatus UT, the image-taking apparatus UT is normally disposed inside the body of the camera, and when a camera function is realized, a configuration as required can be adopted. For example, a unitized image-taking apparatus UT may be formed so as to be freely detachable or freely rotatable relative to the camera body, or a unitized image-taking apparatus UT may be formed so as to be freely detachable or freely rotatable relative to a portable information apparatus (a cellular phone, a PDA, etc.).

In the image-taking apparatus shown in FIG. 7B, a flat-surfaced reflective surface RL is disposed on the optical path in the zoom lens system TL. The reflecting surface RL performs the bending of the optical path for using the zoom lens system TL as a bending optical system, and when this is done, the beam is reflected so that the optical axis AX is bent approximately 90 degrees (that is, 90 degrees or substantially 90 degrees). By thus providing the reflecting surface RL that bends the optical path, on the optical path of the zoom lens system TL, the degree of freedom of the disposition of the image-taking apparatus UT is increased, and reduction in the apparent thickness of the image-taking apparatus UT can be achieved by changing the size, in the direction of the thickness, of the image-taking apparatus UT. In particular, in a case where one negative lens element is disposed on the most object side and the reflecting surface RL is disposed on the image side of the negative lens element like in a second and a third embodiment described later, a significant thickness reduction effect is obtained.

While a prism PR constituting the reflecting surface RL in FIG. 7B is a rectangular prism, the reflecting member used is not limited to a prism. The reflecting surface RL may be formed by using a mirror such as a plane mirror as a reflecting member. Moreover, a reflecting member may be used that reflects the beam so that the optical axis AX of the zoom lens system TL is bent substantially 90 degrees by two or more reflecting surfaces. The optical action for bending the optical path is not limited to reflection, or may be refraction, diffraction or a combination thereof. That is, a bending optical member having a reflecting surface, a refracting surface, a diffracting surface, or a combination thereof may be used.

While the prism PR in FIG. 7B has no optical power (the amount defined by the reciprocal of the focal length), the optical member that bends the optical path may be provided with optical power. For example, by causing the reflecting surface RL, the light incident side surface, the light exit side surface and the like of the prism PR to bear part of the optical power of the zoom lens system TL, the load of power on the lens elements is reduced, whereby the optical performance can be improved. Moreover, the optical path bending position may be any of the front side, the middle and the rear side of the zoom lens system TL. The optical path bending position is set as required, and by approximately bending the optical path, reduction in the apparent thickness and reduction in the size of the digital appliance (digital camera, etc.) on which the image-taking apparatus UT is mounted can be achieved.

The zoom lens system TL includes a plurality of lens units, and magnification variation (that is, zooming) is performed by moving at least one lens unit along the optical axis AX and varying at least one axial distance. The taking lens system used is not limited to the zoom lens system TL. Instead of the zoom lens system TL, a variable focal length lens system of a different type (for example, an image forming optical system whose focal length is variable such as a varifocal lens system, or a multiple focal length lens system) may be used.

As the image sensor SR, for example, a solid-state image sensor such as a CCD (charge coupled device) or a CMOS (complementary metal oxide semiconductor) sensor having a plurality of pixels is used. The optical image formed (on the light receiving surface SS of the image sensor SR) by the zoom lens system TL is converted into an electric signal by the image sensor SR. The signal generated by the image sensor SR undergoes analog-to-digital conversion, predetermined digital image processing, image compression processing and the like as required and is recorded onto a memory (semiconductor memory, optical disk, etc.) as a digital video signal, or in some cases, is transmitted to another appliance through a cable or by being converted into an infrared signal.

The spatial frequency characteristic of the optical image to be formed by the zoom lens system TL is adjusted so that so-called aliasing noise caused when the optical image is converted into an electric signal is minimized by the optical image passing through an optical low-pass filter (corresponding to the plane parallel plate PT in FIG. 7) having a predetermined cutoff frequency characteristic determined by the pixel pitch of the image sensor SR. By doing this, the generation of color moiré can be suppressed. However, suppressing the performance around the resolution limit frequency makes it unnecessary to fear the generation of noise even if no optical low-pass filter is used, and when the user performs image taking or observation by use of a display system where noise is not very conspicuous (for example, the liquid crystal display of a cellular phone), it is unnecessary to use an optical low-pass filter for the taking lens system. Therefore, in an image-taking apparatus not requiring an optical low-pass filter, if the position of the exit pupil is appropriately disposed, size reduction of the image-taking apparatus and the camera can be achieved by reduction in the back focal distance.

As the optical low-pass filter, a birefringent low-pass filter, a phase low-pass filter or the like is applicable. Examples of the birefringent low-pass filter include one made of a birefringent material such as a crystal whose crystallographic axis direction is adjusted to a predetermined direction and one formed by laminating wave plates or the like that change the plane of polarization. Examples of the phase low-pass filter include one that achieves a required optical cutoff frequency characteristic by a diffraction effect.

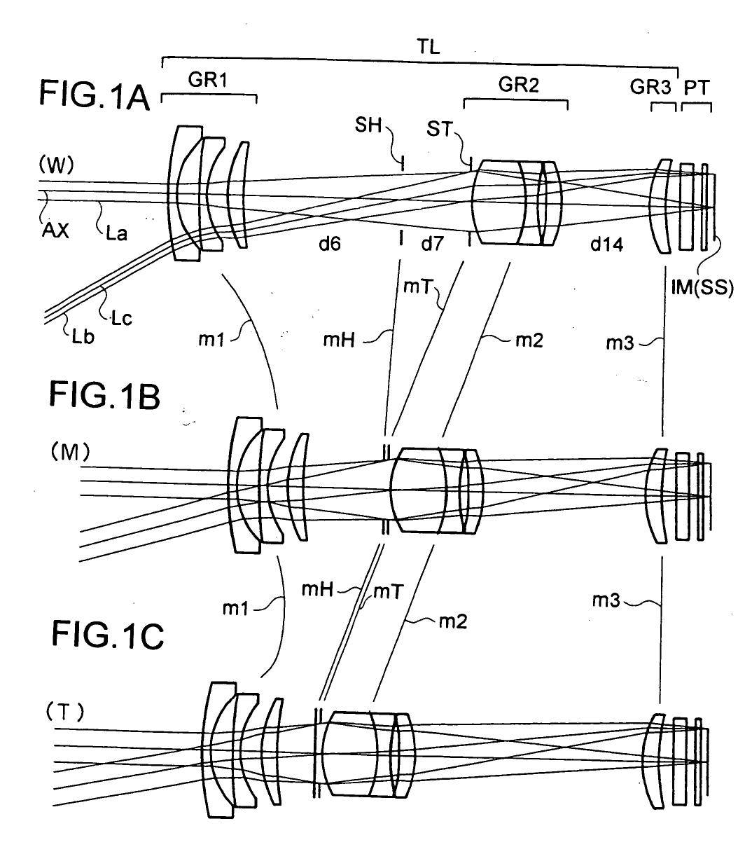

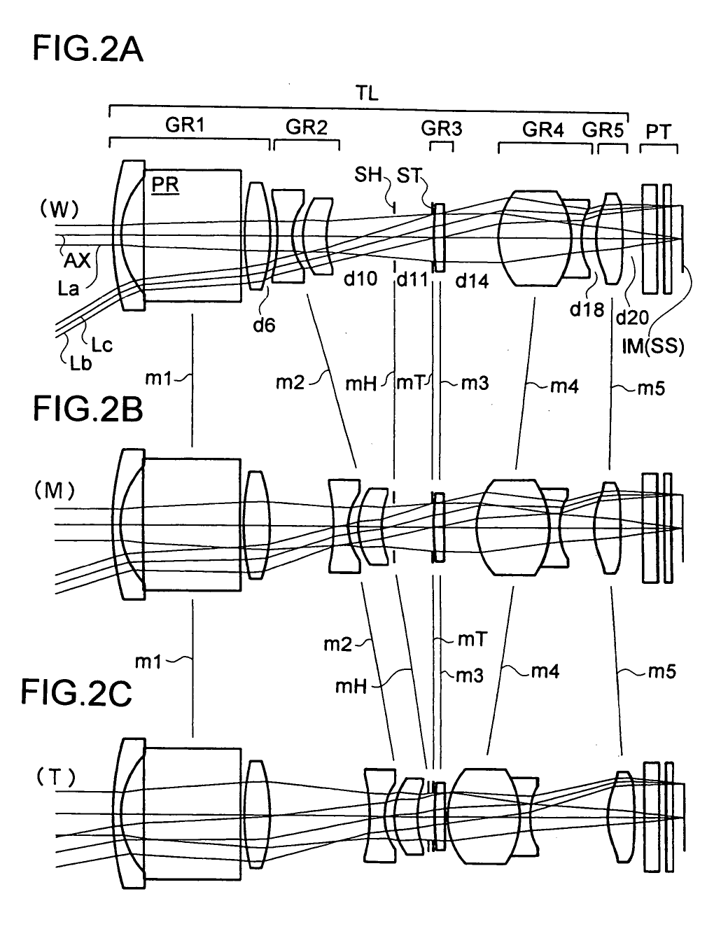

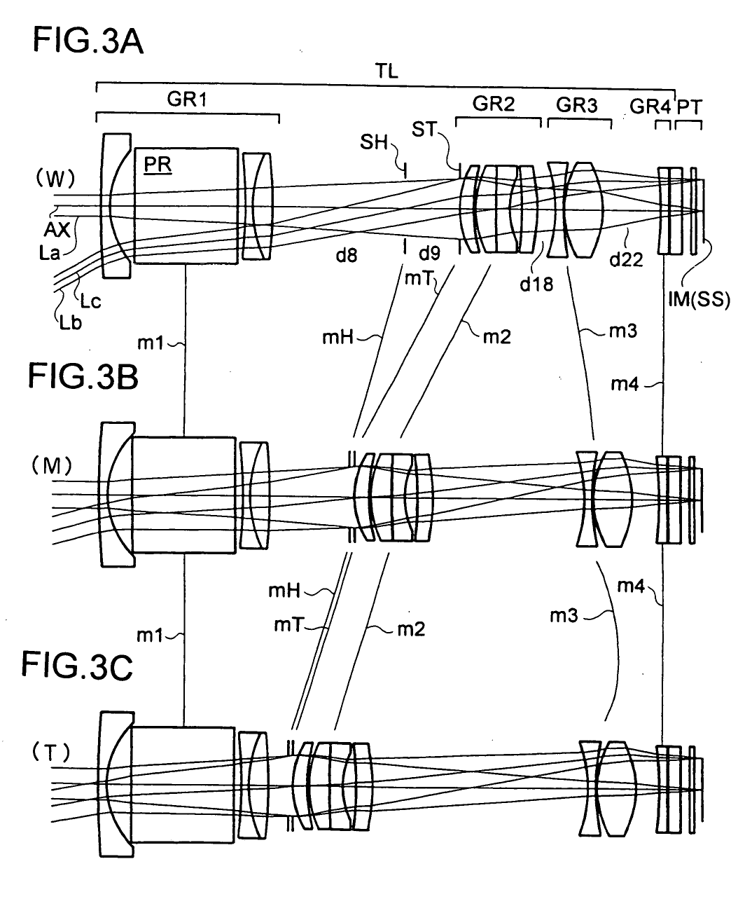

FIGS. 1A-1C to 3A-3C are optical construction diagrams corresponding to the zoom lens systems TL as variable focal length lens systems constituting the first to third embodiments, and show the lens positions and the optical paths at the wide-angle end (W), the middle (M) and the telephoto end (T) by means of optical cross sections (in FIGS. 2A-2C and 3A-3C, optical cross sections in the optical path developed condition of the bending optical system as shown in FIG. 7B). In FIGS. 1A-1C to 3A-3C, lines m1 to m5, mH and mT are the movement loci schematically showing the movements of a first to a fifth lens unit GR1 to GR5, a shutter SH and a aperture stop ST in zooming from the wide-angle end (W) to the middle (M) and from the middle (M) to the telephoto end (T) (that is, the changes of the position relative to the image plane IM), and the axial distance di (i=1, 2, 3, . . . ) is, of the i-th axial distances counted from the object side, a variable distance that varies in zooming. In the first and third embodiments, since the aperture stop ST constitutes a part of the second lens unit GR2, the line mT and the line m2 are parallel to each other. In the second embodiment, since the aperture stop ST constitutes a part of the third lens unit GR3, the line mT and the line m3 are parallel to each other. The plane parallel plate PT is stationary in zooming.

In the zoom lens systems TL of the first to third embodiments, the shutter SH is disposed on the object side of the most image side lens unit, and the aperture stop ST that determines the f-number is disposed separately from the shutter SH. In the first embodiment, the zoom lens system TL has a three-unit zoom construction of negative, positive, positive configuration. In the second embodiment, the zoom lens system TL has a five-unit zoom construction of positive, negative, positive, positive, positive configuration. In the third embodiment, the zoom lens system TL has a four-unit zoom construction of negative, positive, positive, negative configuration. The lens arrangements of the embodiments will be described below in detail.

The first embodiment (FIG. 1) adopts the optical construction of the type in which the optical path is not bent (FIG. 7A), and in the three-unit zoom construction of negative, positive, positive configuration, the lens units have the following construction: The first lens unit GR1 comprises, from the object side, two negative lens elements and one positive lens element. The second lens unit GR2 comprises, from the object side, the aperture stop ST that determines the f-number, a doublet lens element consisting of a positive lens element and a negative lens element, and a positive lens element. The third lens unit GR3 comprises one positive lens element.

In the first embodiment, a shutter unit constituting the shutter SH is disposed between the first lens unit GR1 and the second lens unit GR2. In zooming, the shutter SH moves so that its position relative to the image plane IM is changed. In the zoom range from the wide-angle end (W) to the middle (M), the distance d7 between the shutter SH and the aperture stop ST varies with zooming, whereas in the zoom range from the middle (M) to the telephoto end (T), the distance d7 between the shutter SH and the aperture stop ST does not vary in zooming. That is, in zooming from the telephoto end (T) to the middle (M), the condition where the shutter SH and the aperture stop ST are close to each other is maintained, and in zooming from the middle (M) to the wide-angle end (W), the distance between the shutter SH and the aperture stop ST is increased. While in this embodiment, the aperture stop ST that determines the f-number integrally moves for zooming as a part of the second lens unit GR2, these may be independently moved or one of them may be stationary in zooming.

The second embodiment (FIG. 2) adopts the optical construction of the type in which the optical path is bent (FIG. 7B), and in the five-unit zoom construction of positive, negative, positive, positive, positive configuration, the lens units have the following construction: The first lens unit GR1 comprises, from the object side, a negative lens element, the prism PR for bending the optical axis AX 90 degrees (in this embodiment, a rectangular prism is used) and a positive lens element. The second lens unit GR2 comprises, from the object side, a negative lens element and a positive lens element. The third lens unit GR3 comprises, from the object side, the aperture stop ST that determines the f-number and a positive lens element. The fourth lens unit GR4 comprises a double lens element consisting of, from the object side, a positive lens element and a negative lens element. The fifth lens unit GR5 comprises one positive lens element. With the construction in which the optical axis AX is bent by the prism PR disposed in the first lens unit GR1 of positive optical power like in this embodiment, reduction in the thickness of the digital appliance (digital camera, etc.) CT can be achieved by reduction in the size of the image-taking apparatus UT.

In the second embodiment, a shutter unit constituting the shutter SH is disposed between the second lens unit GR2 and the third lens unit GR3. While the shutter SH moves in zooming so that its position relative to the image plane IM is changed, the zoom position of the aperture stop ST situated on the image side thereof is stationary. In the zoom range from the telephoto end (T) to the middle (M), the distance d11 between the shutter SH and the aperture stop ST varies with zooming, whereas in the zoom range from the middle (M) to the wide-angle end (W), the distance d11 between the shutter SH and the aperture stop ST does not vary in zooming. That is, in zooming from the telephoto end (T) to the middle (M), the distance between the shutter SH and the aperture stop ST is increased, and in zooming from the middle (M) to the wide-angle end (W), the positions of the shutter SH and the aperture stop ST relative to each other are maintained. While in this embodiment, the aperture stop ST that determines the f-number is integrated as a part of the third lens unit GR3, these may be independently moved or one of them may be moved in zooming.

The third embodiment (FIG. 3) adopts the optical construction of the type in which the optical path is bent (FIG. 7B), and in the four-unit zoom construction of negative, positive, positive, negative configuration, the lens units have the following construction. The first lens unit GR1 comprises, from the object side, a negative lens element, the prism PR for bending the optical axis AX 90 degrees (in this embodiment, a rectangular prism is used) and a doublet lens element consisting of a negative lens element and a positive lens element. The second lens unit GR2 comprises, from the object side, the aperture stop ST that determines the f-number, a positive lens element, a doublet lens element consisting of a positive lens element and a negative lens element, and a positive lens element. The third lens unit GR3 comprises, from the object side, a negative lens element and a positive lens element. The fourth lens unit GR4 comprises one negative lens element. With the construction in which the optical axis AX is bent by the prism PR disposed in the first lens unit GR1 of negative optical power like in this embodiment, reduction in the thickness of the digital appliance (digital camera, etc.) CT can be achieved by reduction in the size of the image-taking apparatus UT.

In the third embodiment, a shutter unit constituting the shutter SH is disposed between the first lens unit GR1 and the second lens unit GR2. In zooming, the shutter SH moves so that its position relative to the image plane IM is changed. In the zoom range from the wide-angle end (W) to the middle (M), the distance d9 between the shutter SH and the aperture stop ST varies with zooming, whereas in the zoom range from the middle (M) to the telephoto end (T), the distance d9 between the shutter SH and the aperture stop ST does not vary in zooming. That is, in zooming from the telephoto end (T) to the middle (M), the condition where the shutter SH and the aperture stop ST are close to each other is maintained, and in zooming from the middle (M) to the wide-angle end (W), the distance between the shutter SH and the aperture stop ST is increased. While in this embodiment, the aperture stop ST that determines the f-number integrally moves for zooming as a part of the second lens unit GR2, these may be independently moved or one of them may be stationary in zooming.

While a refractive type lens system that deflects the incident ray by refraction (that is, a lens system of a type in which deflection is performed at the interface between media having different refractive indices) is used as the zoom lens systems TL constituting the embodiments, the lens system that can be used is not limited thereto. For example, the following lens systems may be used: a diffractive type lens system that deflects the incident ray by diffraction; a refractive-diffractive hybrid lens system that deflects the incident ray by a combination of diffraction and refraction; and a gradient index lens system that deflects the incident ray by the distribution of refractive index within the medium. Since the gradient index lens system in which the refractive index changes within the medium leads to a cost increase because of its complicated manufacturing method, it is preferable to use a homogeneous material lens system where the distribution of refractive index is uniform. Moreover, in addition to the aperture stop ST, a beam restricting plate or the like for cutting unnecessary light may be disposed as required.

In the embodiments, in order to reduce the thickness of the image-taking apparatus UT in the direction of the lens diameter, the first lens unit GR1 of the zoom lens system TL is formed to be small in the direction of the lens diameter. This enables reduction in the thickness of the digital appliance (digital camera, etc.) CT and reduction in the area of the lens part on the appearance of the appliance. In the conventional types, the size reduction of the first lens unit causes the above-described phenomenon, and the embodiments prevent the phenomenon from occurring as described below:

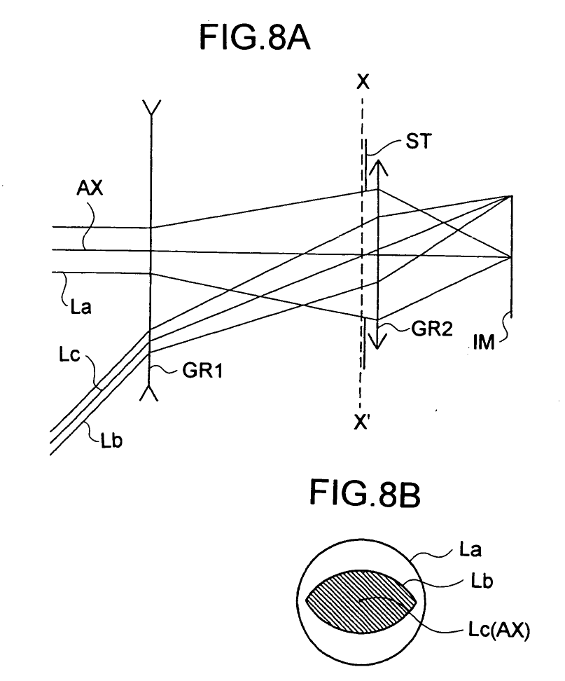

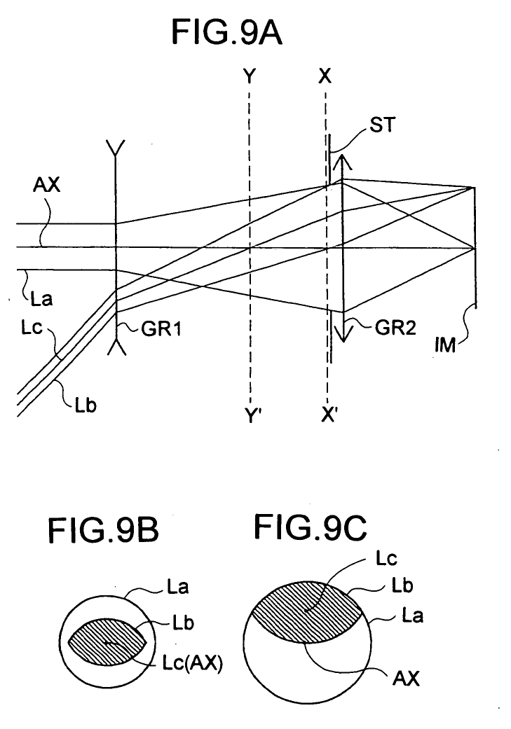

FIG. 8A shows the optical paths of an axial beam La and an off-axial beam Lb (the off-axial beam Lb is imaged at the maximum image height) in a typical two-unit zoom construction of negative, positive configuration, and FIG. 8B shows cross sections, taken on the line X-X′, of the axial beam La and the off-axial beam Lb in FIG. 8A. In the two-unit zoom construction of negative, positive configuration shown in FIG. 8A, the optical paths of the axial beam La and the off-axial beam Lb when the first lens unit GR1 is reduced in the direction of the lens diameter are shown in FIG. 9A. Cross sections, taken on the line Y-Y′, of the axial beam La and the off-axial beam Lb in FIG. 9A are shown in FIG. 9B, and cross sections taken on the line X-X′ are shown in FIG. 9C. In the optical construction shown in FIG. 9A, setting is made so that the off-axial beam Lb passes through the aperture stop ST in order that the brightness of the periphery of the image plane is similar to that in the case of FIG. 8A even if the diameter of the first lens unit GR1 is reduced to cause vignetting in the off-axial beam Lb. Therefore, at the position of the aperture stop ST that determines the f-number, the off-axial beam Lb passes through a position asymmetrical with respect to the optical axis AX as shown in FIGS. 9A and 9C. Consequently, a central ray Lc situated at the center of the cross section of the off-axial beam Lb is situated away from the optical axis AX.

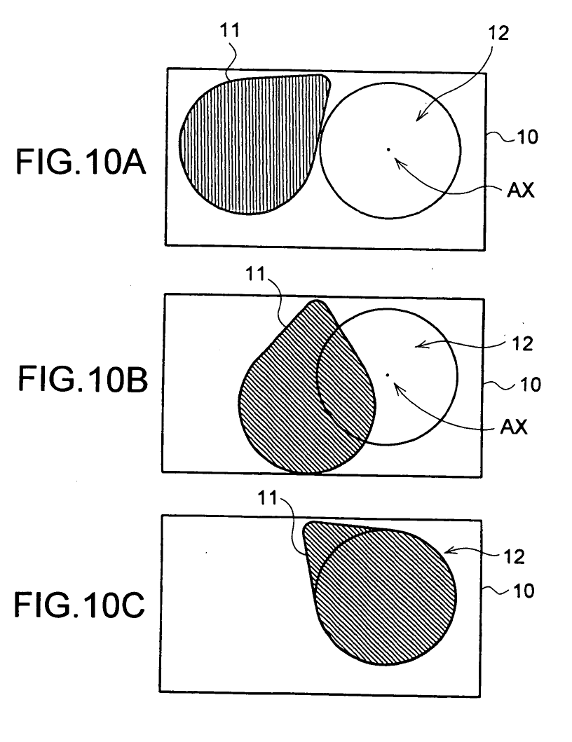

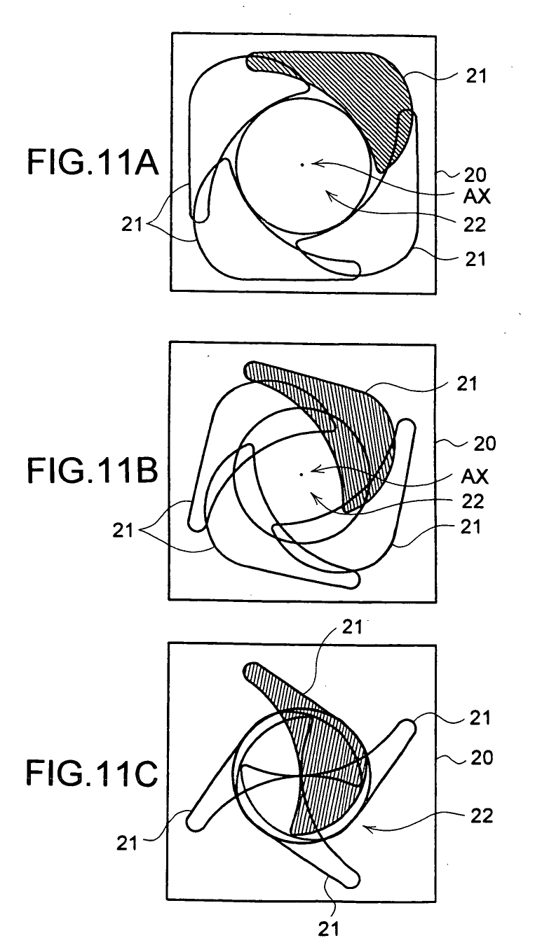

As mentioned above, the shutter unit is frequently disposed in the vicinity of the aperture stop that determines the f-number. Examples of the shutter unit constituting the shutter SH include a single-bladed shutter unit 10 shown in FIGS. 10A to 10C and a four-bladed shutter unit 20 shown in FIGS. 11A to 11C. FIG. 10A shows a shutter opened condition, and FIG. 10C shows a shutter closed condition. FIG. 10B shows a condition where the shutter is being opened or closed, that is, shows a condition where an aperture 12 is partly covered with one shutter blade 11. FIG. 11A shows a shutter opened condition, and FIG. 11C shows a shutter closed condition. FIG. 11B shows a condition where the shutter is being opened or closed, that is, shows a condition where an aperture 22 is partly covered with four shutter blades 21.

When the off-axial beam Lb (FIG. 9C) asymmetrical with respect to the optical axis AX is intercepted by high-speed shutter release by use of the single-bladed shutter unit 10 as shown in FIGS. 10A to 10C, the off-axial beam Lb is nonuniformly cut, so that the light quantity is different between both ends of the formed image. When the off-axial beam Lb is cut symmetrically with respect to the optical axis AX by use of the four-bladed shutter unit 20 as shown in FIGS. 11A to 11C, it is possible to eliminate the difference in light quantity and obtain an image with no illumination nonuniformity. However, since a driving mechanism for moving the four shutter blades 21 is required, the cost of the shutter unit 20 is increased. Moreover, since it is necessary to secure a space for the four shutter blades 21 to retract into, the shutter unit 20 is increased in size, so that it is difficult to reduce the thickness of the entire image-taking apparatus UT. On the contrary, the single-bladed shutter unit 10 having a simplified construction is small in size and low in cost. For example, when the single-bladed shutter unit 10 shown in FIGS. 10A to 10C is used, by disposing it so that the direction of its short sides coincides with the direction of the thickness of the digital appliance (digital camera, etc.) CT, the thickness of the digital appliance CT can be reduced.

In order that the off-axial beam Lb (FIGS. 9A to 9C) can be cut symmetrically with respect to the optical axis AX even when a small-size and low-cost shutter unit is used, in the embodiments (FIGS. 1A-1C to 3A-3C), the shutter SH is disposed on the object side of the most image side lens unit, the aperture stop ST that determines the f-number is disposed separately from the shutter SH, and a magnification variation range is provided where the distance between the shutter SH and the aperture stop ST varies with magnification variation. This construction enables the off-axial beam Lb to be uniformly cut by the shutter SH even if the first lens unit GR1 is small in the direction of the lens diameter, so that the light quantity can be prevented from being different between both ends of the formed image. Consequently, the thickness of the entire image-taking apparatus UT can be reduced in the direction of the lens diameter, and a formed image with uniform brightness can be obtained even when an inexpensive and small-size shutter unit is used. The use of the image-taking apparatus UT for appliances such as digital cameras and personal digital assistants contributes to a smaller thickness, a smaller size, higher performance, higher functionality, lower cost and the like of these appliances.

At the wide-angle end (W) of the embodiments (FIGS. 1A-1C to 3A-3C), since the diameter of the first lens unit GR1 is small, the off-axial beam Lb in the position of the aperture stop ST is away from the optical axis AX. When the off-axial beam Lb is cut in the position of the aperture stop ST from one side by the shutter SH (see FIGS. 10A to 10C), the light quantity is different between both sides of the formed image as mentioned above. By disposing the shutter SH in a position different from the position of the aperture stop ST, the off-axial beam Lb can be uniformly cut by the shutter SH, so that the light quantity can be prevented from being different within the image plane. The optimum position of the shutter SH for obtaining this effect is the position of intersection of the central ray Lc of the off-axial beam Lb and the optical axis AX, and in the embodiments, the shutter SH is situated in the position of intersection or in the vicinity thereof. That is, in the zoom lens systems TL of the embodiments, the shutter SH is disposed on the object side of the most image side lens unit, the aperture stop ST that determines the f-number is disposed separately from the shutter SH, and the shutter SH is situated in the position of intersection of the central ray Lc of the off-axial beam Lb that is imaged at the maximum image height, and the optical axis AX or in the vicinity thereof. The adjustment of the disposition is performed by varying the distance between the shutter SH and the aperture stop SH with zooming.

The position of intersection between the central ray Lc of the off-axial beam Lb and the optical axis AX corresponds to the position of the line Y-Y′ in FIG. 9A, and in the position of intersection, the symmetry of the off-axial beam Lb with respect to the optical axis AX is highest as shown in FIG. 9B. Therefore, it is preferable that the shutter SH be situated in the vicinity of the point of intersection of the central ray Lc of the off-axial beam Lb that is imaged at the maximum image height and the optical axis AX. It is preferable that the shutter SH be situated in the lens-unit-to-lens-unit interval including the point of intersection of the central ray Lc of the off-axial beam Lb that is imaged at the maximum image height and the optical axis AX, and this facilitates the suppression of the difference in light quantity within the image plane.

When the shutter SH is disposed in the vicinity of the point of intersection of the central ray Lc of the off-axial beam Lb and the optical axis AX as described above, it is preferable to move the shutter SH so that its position relative to the image plane IM is changed during zooming. In the first and third embodiments, the shutter SH moves to the position of the aperture stop ST in magnification variation from the wide-angle end (W) to the middle (M), and in the second embodiment, the shutter SH moves to the position of the aperture stop ST in magnification variation from the middle (M) to the telephoto end (T). At the telephoto end (T), the asymmetry of the off-axial beam Lb with respect to the optical axis AX in the position of the aperture stop ST is low, so that the light quantity is hardly different within the image plane. Consequently, it is preferable to move the shutter SH to the position of the aperture stop ST in magnification variation from the wide-angle end (W) to the telephoto end (T). This enables the space for the movements of the lens units to be effectively used, so that the zoom lens system TL can be reduced in size.

In the first and third embodiments, the distance between the shutter SH and the aperture stop ST does not vary in the zoom range from the middle (M) to the telephoto end (T), and in the second embodiment, the distance between the shutter SH and the aperture stop ST does not vary in the zoom range from the middle (M) to the wide-angle end (W). It is preferable to further provide a magnification variation range where the distance between the shutter SH and the aperture stop ST does not vary during magnification variation as described above. A construction in which the distance between the shutter SH and the aperture stop ST is fixed in some magnification variation ranges enables a simplification of the lens barrel such that, for example, by biasing the shutter SH in one direction with a biasing member such as a spring and providing a stopper such as a protrusion for stopping it, the zoom position is fixed until the shutter SH comes into contact with a movable lens unit and after coming into contact, the shutter SH is moved for zooming integrally with the movable lens unit against the pushing force of the pushing means by the driving force of the movable unit. Consequently, a driver for the exclusive use of the shutter is unnecessary, so that the image-taking apparatus UT can be inexpensively formed.

With respect to the disposition of the shutter SH, it is preferable that the aperture stop ST be situated on the most object side in a predetermined lens unit, the shutter SH be situated between the predetermined lens unit and a lens unit adjoining the predetermined lens unit on the object side and the following condition (1) be fulfilled:
0.1<Sw/Tw<0.6 (1)
where
Sw is the distance between the shutter and the aperture stop at the wide-angle end, and
Tw is the lens-unit-to-lens-unit interval including the shutter at the wide-angle end.

By fulfilling the condition (1), the difference in light quantity within the image plane can be more excellently suppressed. When the upper limit or the lower limit of the condition (1) is exceeded, the off-axial beam that is imaged at the maximum image height passes through a position away from the optical axis at the position of the shutter, so that a sufficient light quantity difference reducing effect cannot be obtained.

It is further preferable to fulfill the following condition (1a):
0.2<Sw/Tw<0.5 (1a)

The condition (1a) defines a further preferable condition range, based on the above-mentioned viewpoint, of the condition range defined by the condition (1). By fulfilling the condition (1a), the light quantity difference within the image plane can be further effectively suppressed.

With respect to the distance between the shutter SH and the aperture stop ST, it is preferable to fulfill the following condition (2):
Sw>St (2)
where
Sw is the distance between the shutter and the aperture stop at the wide-angle end, and
St is the distance between the shutter and the aperture stop at the telephoto end.

When the reduction in the thickness of the first lens unit GR1 in the direction of the lens diameter is advanced, the asymmetry of the off-axial beam Lb with respect to the optical axis AX tends to be higher at the wide-angle end (W) than at the telephoto end (T). That is, the point of intersection of the central ray Lc and the optical axis AX tends to be away from the position of the aperture stop ST on the wide-angle side. Therefore, it is preferable that the distance between the aperture stop ST that determines the f-number and the shutter SH be shorter at the telephoto end (T) than at the wide-angle end (W). Therefore, it is preferable to fulfill the condition (2), and this enables the space for the movements of the lens units to be effectively used, so that the zoom lens system TL can be reduced in size.

It is preferable that the aperture diameter of the aperture stop ST not be changed at least for light amount adjustment for exposure, and it is further preferable to use a aperture stop with a fixed aperture diameter as the aperture stop ST. In a construction where the off-axial beam Lb passes through a position asymmetrical with respect to the optical axis AX in the position of the aperture stop ST that determines the f-number, when the light quantity for exposure is adjusted by changing the aperture diameter, the off-axial beam Lb is vignetted, so that the periphery of the image plane is darker than the central part of the image plane. Therefore, when the light quantity for exposure is adjusted by changing the aperture diameter, it is necessary that the off-axial beam Lb pass in the vicinity of the optical axis AX in the position of the aperture stop ST. However, this makes it impossible to reduce the size of the first lens unit GR1. With the construction in which the aperture diameter is not changed at least for light amount adjustment for exposure, this problem is solved to enable the reduction in the size of the first lens unit GR1 and the reduction in the thickness of the entire image-taking apparatus UT. Moreover, by using a aperture stop with a fixed aperture diameter as the aperture stop ST, the cost of the aperture stop unit can be reduced. By using an ND (neutral density) filter or the like instead of changing the aperture diameter, the light quantity can be adjusted.

In a variable focal length lens system in which at least the first lens unit GR1 having negative optical power and the second lens unit GR2 having positive optical power are provided from the object side and at least the distance between the first lens unit GR1 and the second lens unit GR2 varies in magnification variation from the wide-angle end (W) to the telephoto end (T) like the zoom lens systems TL used in the first and third embodiments, the above-mentioned point of intersection where the shutter SH is to be disposed is apt to occur between the first lens unit GR1 and the second lens unit GR2. For this reason, it is preferable that the shutter SH be situated between the first lens unit GR1 and the second lens unit GR2 and the aperture stop ST be situated in the second lens unit GR2. Moreover, in a variable focal length lens system in which at least the first lens unit GR1 having positive optical power, the second lens unit GR2 having negative optical power and the third lens unit GR3 are provided from the object side and at least the distance between the second lens unit GR2 and the third lens unit GR3 varies in magnification variation from the wide-angle end (W) to the telephoto end (T) like the zoom lens system TL used in the second embodiment, the above-mentioned point of intersection where the shutter SH is to be disposed is apt to occur between the second lens unit GR2 and the third lens unit GR3. For this reason, it is preferable that the shutter SH be situated between the second lens unit GR2 and the third lens unit GR3 and the aperture stop ST be situated in the third lens unit GR3.

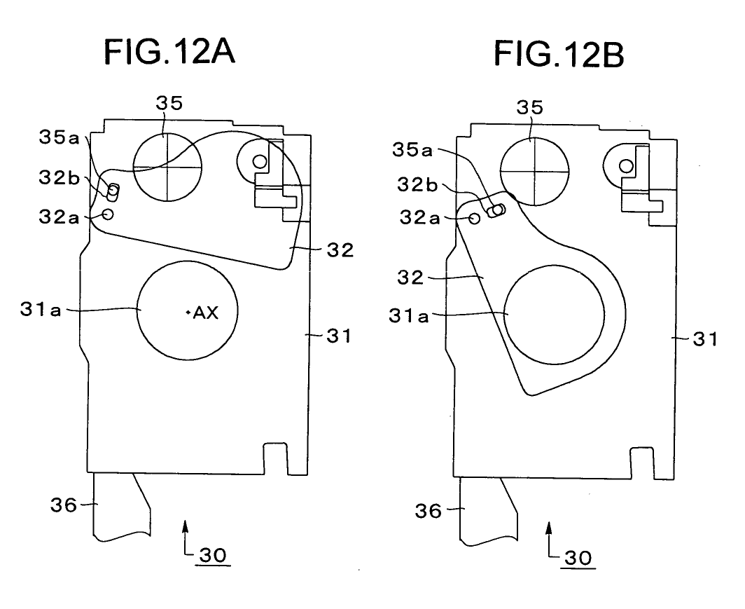

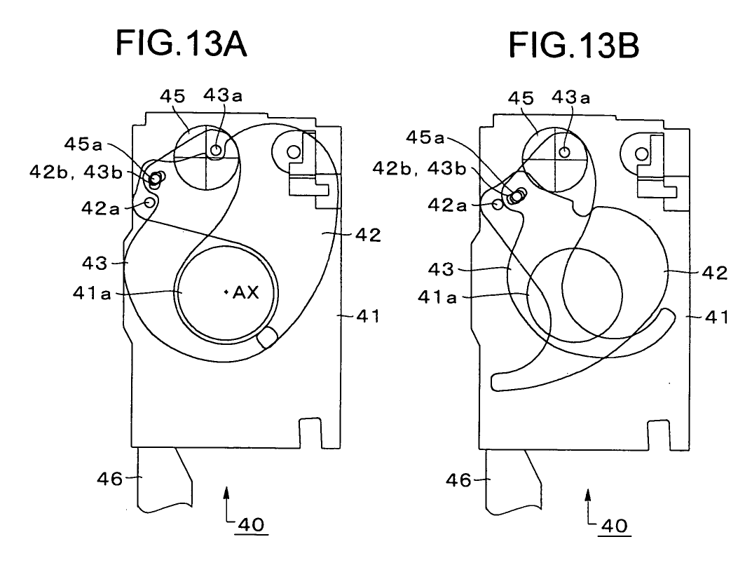

Next, a shutter unit that can be suitably used in the embodiments will be described with concrete examples. The examples shown here are, as shown in FIGS. 12A, 12B, 13A and 13B, shutter units 30 and 40 of a type that opens and closes the shutter asymmetrically with respect to the optical axis AX. The shutter units 30 and 40 having a simplified construction are small in size and low in cost, and the use thereof contributes to a smaller size and lower cost of the image-taking apparatus UT. The horizontal direction of FIGS. 12A, 12B, 13A and 13B corresponds to the direction of the thickness of the image-taking apparatus UT and the digital appliance CT.

FIG. 12A shows the single-bladed shutter unit 30 in the shutter opened condition. FIG. 12B shows the single-bladed shutter unit 30 in the shutter closed condition. The shutter unit 30 constitutes the above-mentioned shutter SH, and comprises: a board 31 having an aperture 31a; a shutter blade 32 that opens and closes the aperture 31a; and a driver 35 that drives the shutter blade 32. The board 31 is provided with the driver 35 for driving the shutter blade 32. The driver 35 comprises a moving magnet, a coil or the like, and is connected to a flexible board 36 for supplying it with power, a control signal and the like.

The shutter blade 32 is provided with a pin 32a as the central axis of its rotation, and a hole (not shown) receiving the pin 32a is formed in the board 31. Moreover, the shutter blade 32 is provided with an elongate hole 32b, and a pin 35a is fitted in the elongate hole 32b. The pin 35a is provided on a lever-form member (not shown) that is swung by the driver 35. Consequently, when the pin 35a is moved by the driver 35, the shutter blade 32 rotates about the pin 32a, so that the aperture 31a is in the opened condition (A) or the closed condition (B).

FIG. 13A shows the two-bladed shutter unit 40 in the shutter opened condition. FIG. 13B shows the two-bladed shutter unit 40 in the shutter closed condition. The shutter unit 40 constitutes the above-mentioned shutter SH, and comprises: a board 41 having an aperture 41a; two shutter blades 42 and 43 that open and close the aperture 41a; and a driver 45 that drives the shutter blades 42 and 43. The board 41 is provided with the driver 45 for driving the shutter blades 42 and 43. The driver 45 comprises a moving magnet, a coil or the like, and is connected to a flexible board 46 for supplying it with power, a control signal and the like.

The shutter blades 42 and 43 are provided with pins 42a and 43a as the central axes of their rotation, respectively, and holes (not shown) receiving the pins 42a and 43a are formed in the board 41. Moreover, the shutter blades 42 and 43 are provided with elongate holes 42b and 43b, respectively, and the pin 45a is inserted in the overlapping part of the elongate holes 42b and 43b. The pin 45a is provided on a lever-form member (not shown) that is swung by the driver 45. Consequently, when the pin 45a is moved by the driver 45, the shutter blades 42 and 43 rotate about the pins 42a and 43a at the same time, so that the aperture 41a is in the opened condition (A) or the closed condition (B).

The above-described embodiments and examples described later (Z1-D2) include the following construction, and according to the construction, the thickness reduction in the direction of the lens diameter is achieved, and a taking lens system capable of obtaining an optical image with uniform brightness even when an inexpensive and small-size shutter unit is used can be realized. The use of the taking lens system for digital appliances such as digital cameras and portable information apparatuses (cellular phones, PDA, etc.) contributes to a smaller thickness, a lighter weight, a smaller size, lower cost, higher performance and higher functionality of the apparatuses.

(Z1) A variable focal length lens system comprising a plurality of lens units and performing magnification variation by moving at least one lens unit along the optical axis, wherein the shutter is disposed on the object side of the most image side lens unit, the aperture stop that determines the f-number is disposed separately from the shutter, and a magnification variation range where the distance between the shutter and the aperture stop varies with magnification variation is provided.

(Z2) A variable focal length lens system according to (Z1), wherein the shutter moves so that its position relative to the image plane changes during magnification variation.

(Z3) A variable focal length lens system according to (Z1) or (Z2), wherein a magnification variation range where the distance between the shutter and the aperture stop does not vary during magnification variation is further provided.

(Z4) A variable focal length lens system according to one of (Z1) to (Z3), wherein the shutter is situated in the lens-unit-to-lens-unit interval including the point of intersection of the central ray of the off-axial beam that is imaged at the maximum image height and the optical axis.

(Z5) A variable focal length lens system according to one of (Z1) to (Z4), wherein the shutter is situated at the point of intersection of the central ray of the off-axial beam that is imaged at the maximum image height and the optical axis, or in the vicinity of the point.

(Z6) A variable focal length lens system according to one of (Z1) to (Z5), wherein the aperture stop is situated in a predetermined lens unit, the shutter is situated between the predetermined lens unit and a lens unit adjoining the predetermined lens unit on the object side, and the condition (1) or (1a) is fulfilled.

(Z7) A variable focal length lens system according to one of (Z1) to (Z6), wherein the condition (2) is fulfilled.

(Z8) A variable focal length lens system according to one of (Z1) to (Z7), wherein the aperture diameter of the aperture stop does not change at least during exposure.

(Z9) A variable focal length lens system according to one of (Z1) to (Z8), comprising, from the object side, at least a first lens unit having negative optical power and a second lens unit having positive optical power, wherein at least the distance between the first lens unit and the second lens unit varies in magnification variation from the wide-angle end to the telephoto end, the shutter is situated between the first lens unit and the second lens unit, and the aperture stop is situated in the second lens unit.

(Z10) A variable focal length lens system according to one of (Z1) to (Z8), comprising, from the object side, at least a first lens unit having positive optical power, a second lens unit having negative optical power and a third lens unit, wherein at least the distance between the second lens unit and the third lens unit varies in magnification variation from the wide-angle end to the telephoto end, the shutter is situated between the second lens unit and the third lens unit, and the aperture stop is situated in the third lens unit.

(Z11) A variable focal length lens system comprising a plurality of lens units and performing magnification variation by moving at least one lens unit along an optical axis, wherein the shutter is disposed on the object side of the most image side lens unit, the aperture stop that determines the f-number is disposed separately from the shutter, and in a predetermined magnification variation range, the shutter is situated at the point of intersection of the central ray of the off-axial beam that is imaged at the maximum image height and the optical axis, or in the vicinity of the point.

(Z12) A variable focal length lens system comprising a plurality of lens units and performing magnification variation by moving at least one lens unit along the optical axis, wherein the shutter is disposed on the object side of the most image side lens unit, the aperture stop that determines the f-number is disposed separately from the shutter, and the shutter moves during magnification variation so that the shutter is situated at the point of intersection of the central ray of the off-axial beam that is imaged at the maximum image height and the optical axis, or in the vicinity of the point.

(Z13) A taking lens system for forming an optical image of an object on the light receiving surface of an image sensor, wherein the shutter is disposed on the object side of the most image side lens unit, the aperture stop that determines the f-number is disposed separately from the shutter, and the shutter is situated in the lens-unit-to-lens-unit distance including the point of intersection of the central ray of the off-axial beam that is imaged at the maximum image height and the optical axis.

(Z14) A taking lens system for forming an optical image of an object on the light receiving surface of an image sensor, wherein the shutter is disposed on the object side of the most image side lens unit, the aperture stop that determines the f-number is disposed separately from the shutter, and the shutter is situated at the point of intersection of the central ray of the off-axial beam that is imaged at the maximum image height and the optical axis, or in the vicinity of the point.

(U1) An image-taking apparatus comprising: the variable focal length lens system according to one of (Z1) to (Z12); and an image sensor that converts an optical image formed by the variable focal length lens system into an electric signal.

(U2) An image-taking apparatus comprising: the taking lens system according to (Z13) or (Z14); and an image sensor that converts an optical image formed by the variable focal length lens system into an electric signal.

(C1) A camera comprising the image-taking apparatus according to (U1) or (U2) and being used for at least one of taking of a still image of the subject or taking of a moving image of the subject.

(C2) A camera according to claim (C1), being incorporated in or externally attached to a digital camera; a video camera; or a cellular phone, a personal digital assistant, a personal computer, a mobile computer, or a peripheral thereof.

(D1) A digital appliance to which at least one of a function of taking a still image of the subject or a function of taking a moving image of the subject is added by being provided with the image-taking apparatus according to (U1) or (U2).

(D2) A digital appliance according to (D1), being a cellular phone, a personal digital assistant, a personal computer, a mobile computer, or a peripheral thereof.

### EXAMPLES

Hereinafter, the construction and other features of practical examples of the zoom lens systems used in the optical apparatus embodying the present invention will be presented with reference to their construction data and other data. Examples 1 to 3 presented below are numerical examples corresponding to the first to third embodiments, respectively, described hereinbefore, and therefore the optical construction diagrams (FIGS. 1A-1C to 3A-3C) of the first to third embodiments show the lens construction of Examples 1 to 3, respectively.

Tables 1 to 6 show the construction data of Examples 1 to 3. Table 7 shows the values of the conditional formulae and the data related thereto as actually observed in each example. In the basic optical structures (with “i” representing the surface number) presented in Tables 1, 3 and 5, ri (i=1, 2, 3, . . . ) represents the radius of curvature (in mm) of the i-th surface counted from the object side, and di (i=1, 2, 3, . . . ) represents the axial distance (in mm) between the i-th surface and the (i+1)-th surface counted from the object side. Ni (i=1, 2, 3, . . . ) and νi (i=1, 2, 3, . . . ) represent the refractive index (Nd) for the d-line and the Abbe number (νd) of an optical material filling the axial distance di. The axial distance di that varies in zooming is a variable air space at the wide-angle end (shortest focal length condition, W), the middle (middle focal length condition, M) and the telephoto end (longest focal length condition, T), and f and FNO show the focal lengths (in mm) and f-numbers of the entire lens system corresponding to the focal length conditions (W), (M) and (T), respectively.

The surfaces whose data of the radius of curvature ri is marked with * are aspherical surfaces (a refractive optical surface having an aspherical shape, a surface having the property of refraction equal to that of an aspherical surface, etc.), and are defined by the following expression (AS) expressing the configuration of an aspherical surface. Tables 2, 4 and 6 show aspherical data of the examples. The coefficients of the terms not shown are 0, and E−n=×10⁻ⁿ for all the data.
X(H)=(C0·H²)/{1×√(1−ε·CO²·H²)}+Σ(Aj·H^{j}) (AS)
In the expression (AS), X(H) is the amount of displacement in the direction of the optical axis AX at a height H (with the vertex as the reference), H is the height in a direction perpendicular to the optical axis AX, C0 is a paraxial curvature (=1/ri), ε is a quadric surface parameter, and Aj is the j-th aspherical coefficient.

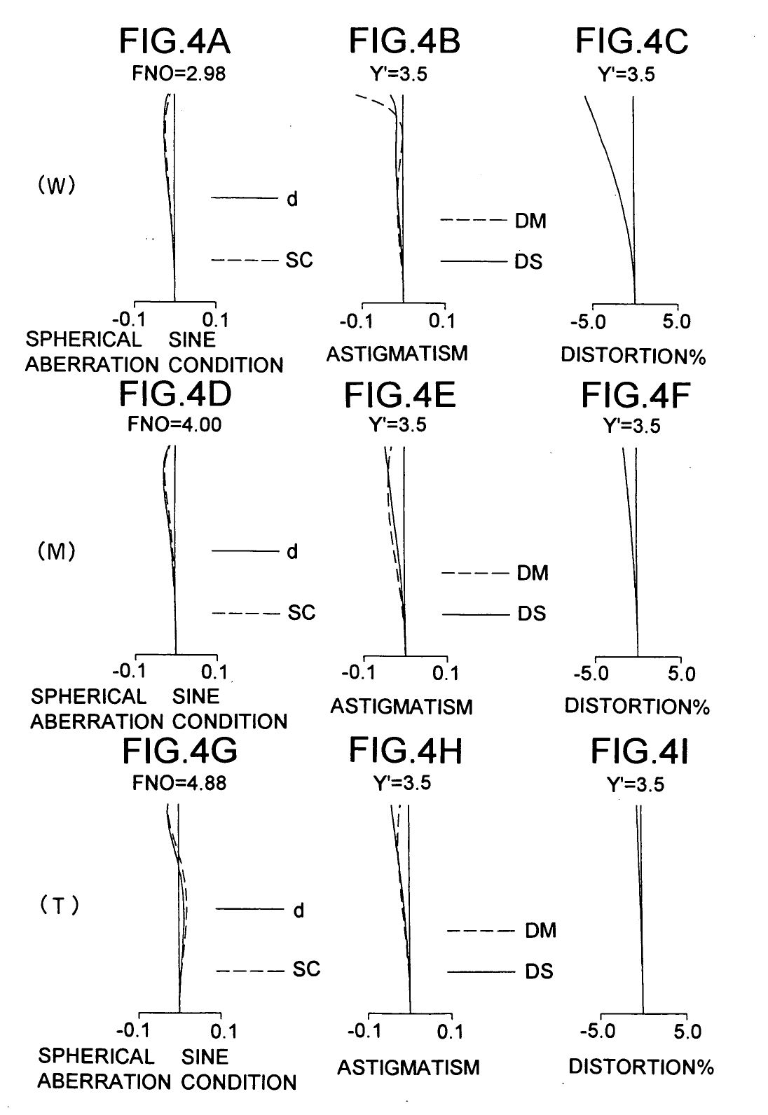

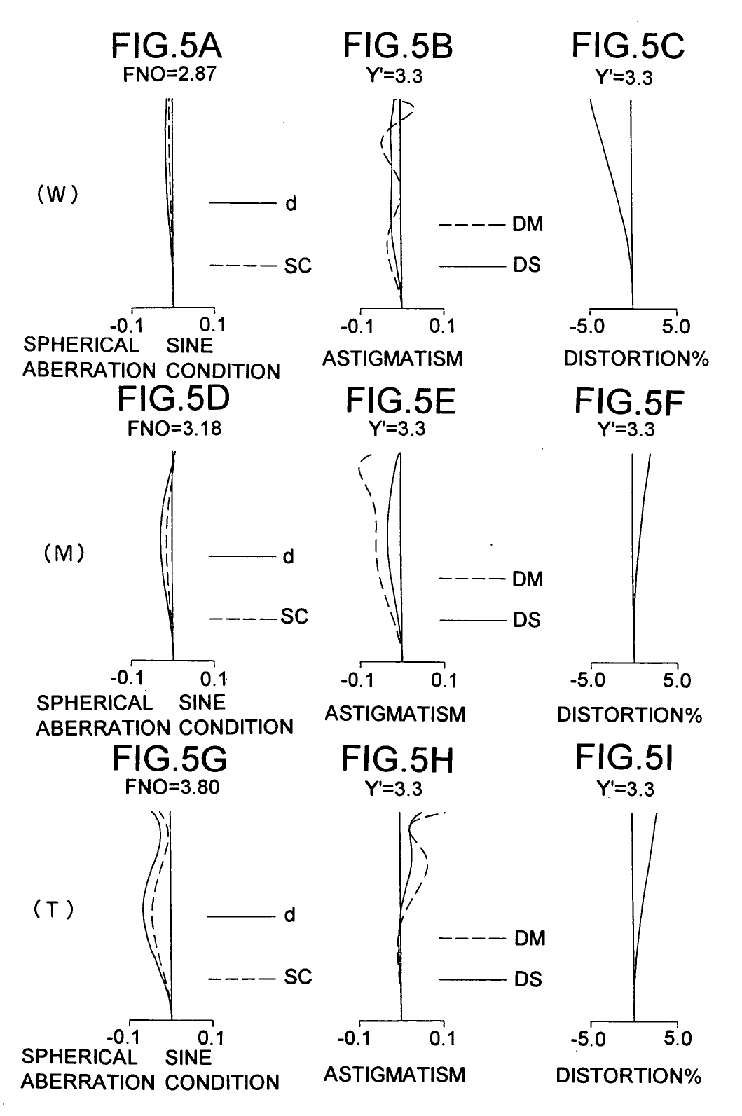

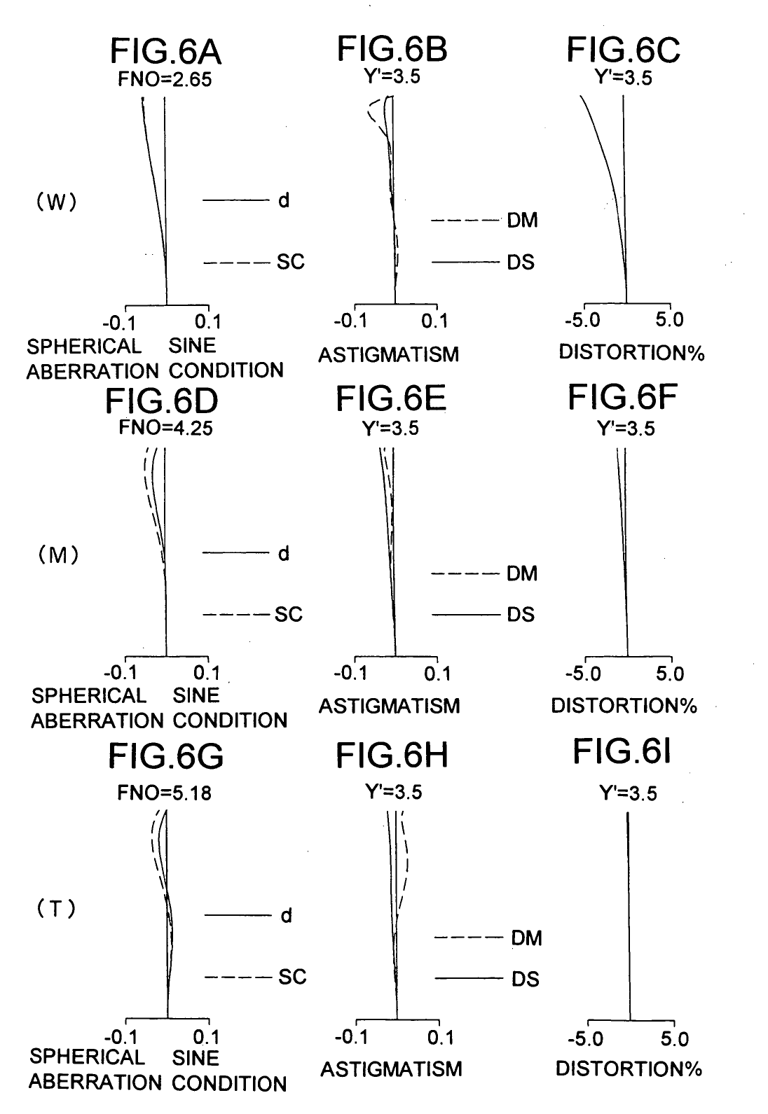

FIGS. 4A-4I to 6A-6I are aberration diagrams of Examples 1 to 3. FIGS. 4A-4C, 5A-5C and 6A-6C show aberrations {from the left, spherical aberration and sine condition, astigmatism, and distortion. FNO is the f-number, and Y′ (mm) is the maximum image height (corresponding to the distance from the optical axis AX) on the light receiving surface SS of the image sensor SR} in the infinity in-focus state at the wide-angle end (W), FIGS. 4D-4F, 5D-5F and 6D-7F show the aberrations in the infinity in-focus state at the middle (M), and FIGS. 4G-4I, 5G-5I and 6G-6I show the aberrations in the infinity in-focus state at the telephoto end (T). In FIGS. 4A, 4D, 4G, 5A, 5D, 5G, 6A, 6D and 6G, the solid line d represents the amount of spherical aberration (mm) observed for the d-line, and the broken line SC represents the deviation (mm) from the sine condition to be fulfilled. In FIGS. 4B, 4E, 4H, 5B, 5E, 5H, 6B, 6E and 6H, the broken line DM and the solid line DS represent astigmatisms (mm) observed for the d-line on the meridional and sagittal planes, respectively. In FIGS. 4C, 4F, 4I, 5C, 5F, 5I, 6C, 6F and 6I, the solid line represents the distortion (%) observed for the d-line.

TABLE 1

| | | | Focal Length | | | |
|---|---|---|---|---|---|---|
| | | | Condition | W | M | T |
| | | | f [mm] | 5.91 | 11.81 | 16.83 |
| Example 1 | | | FNO | 2.98 | 4.01 | 4.88 |
| i | ri [mm] | | di [mm] | Ni | νi | Element, etc. |
| 1 | 25.721 | | 0.900 | 1.62041 | 60.34 | GR1(−) |
| 2 | 8.000 | | 2.500 | | | |
| 3 | 130.430 | * | 0.800 | 1.51680 | 64.20 | |
| 4 | 7.429 | * | 2.452 | | | |
| 5 | 12.486 | | 2.765 | 1.71736 | 29.50 | |
| 6 | 38.387 | | 15.109(W)˜7.277(M)˜3.016(T) | | | |
| 7 | ∞ | | 6.923(W)˜0.500(M)˜0.500(T) | | | SH |
| 8 | ∞ | | 0.200 | | | ST |
| 9 | 8.619 | | 5.867 | 1.71300 | 53.94 | GR2(+) |
| 10 | −13.696 | | 0.010 | 1.51400 | 42.83 | |
| 11 | −13.696 | | 1.382 | 1.76182 | 26.61 | |
| 12 | 19.087 | | 0.942 | | | |
| 13 | −27.379 | * | 1.650 | 1.53048 | 55.72 | |
| 14 | −12.086 | * | 9.190(W)˜17.026(M)˜23.687(T) | | | |
| 15 | 10.368 | | 1.750 | 1.48749 | 70.44 | GR3(+) |
| 16 | 26.216 | | 1.500 | | | |
| 17 | ∞ | | 1.280 | 1.54426 | 69.60 | PT |
| 18 | ∞ | | 0.940 | | | |
| 19 | ∞ | | 0.500 | 1.51680 | 64.20 | |
| 20 | ∞ | | 0.800 | | | |
| 21 | ∞ | | | | | IM(SR) |

TABLE 2
Example 1
Aspherical Surface Data of i-th Surface (*)

| | 3rd Surface | 4th Surface |
|---|---|---|
| ε | 1.0000 | 1.0000 |
| A4 | −0.71822000E−4 | −0.41045000E−3 |
| A6 | 0.27670000E−5 | 0.98519000E−6 |
| A8 | | −0.64261000E−7 |
| | 13th Surface | 14th Surface |
| ε | 1.0000 | 1.0000 |
| A4 | −0.13137000E−2 | −0.48685000E−3 |
| A6 | −0.74754000E−5 | 0.12928000E−5 |
| A8 | 0.14158000E−5 | 0.14199000E−5 |
| A10 | −0.73089000E−8 | −0.98191000E−8 |

TABLE 3

| | | | Focal Length | | | |
|---|---|---|---|---|---|---|
| | | | Condition | W | M | T |
| | | | f [mm] | 6.00 | 10.50 | 17.28 |
| Example 2 | | | FNO | 2.87 | 3.19 | 3.80 |
| i | ri [mm] | | di [mm] | Ni | νi | Element, etc. |
| 1 | 29.199 | | 0.800 | 1.84666 | 23.82 | GR1(+) |
| 2 | 9.088 | | 2.359 | | | |
| 3 | ∞ | | 10.000 | 2.02204 | 29.06 | PR |
| 4 | ∞ | | 0.356 | | | |
| 5 | 26.535 | | 2.634 | 1.78800 | 47.49 | |
| 6 | −18.142 | | 0.700(W)˜6.497(M)˜10.163(T) | | | |
| 7 | −17.378 | * | 1.500 | 1.52200 | 52.20 | GR2(−) |
| 8 | 5.753 | * | 1.008 | | | |
| 9 | 6.962 | | 2.439 | 1.84666 | 23.82 | |
| 10 | 9.258 | | 7.116(W)˜1.319(M)˜1.183(T) | | | |
| 11 | ∞ | | 4.031(W)˜4.031(M)˜0.500(T) | | | SH |
| 12 | ∞ | | 0.100 | | | ST |
| 13 | 31.382 | | 1.120 | 1.75450 | 51.57 | GR3(+) |
| 14 | −187.707 | | 5.600(W)˜3.414(M)˜0.300(T) | | | |
| 15 | 7.640 | | 7.516 | 1.75450 | 51.57 | GR4(+) |
| 16 | −9.000 | | 0.010 | 1.51400 | 42.83 | |
| 17 | −9.000 | | 1.000 | 1.84666 | 23.82 | |
| 18 | 8.421 | * | 1.490(W)˜3.456(M)˜7.786(T) | | | |
| 19 | 8.000 | * | 2.684 | 1.52200 | 52.20 | GR5(+) |
| 20 | −85.136 | * | 2.095(W)˜2.315(M)˜1.100(T) | | | |
| 21 | ∞ | | 1.500 | 1.51680 | 64.20 | PT |
| 22 | ∞ | | 0.700 | | | |
| 23 | ∞ | | 0.750 | 1.51680 | 64.20 | |
| 24 | ∞ | | 1.190 | | | |
| 25 | ∞ | | | | | IM(SR) |

TABLE 4
Example 2
Aspherical Surface Data of i-th Surface (*)

| | 7th Surface | 8th Surface |
|---|---|---|
| ε | 1.0000 | 1.0000 |
| A4 | −0.14083000E−3 | −0.53948000E−3 |
| A6 | 0.32862000E−4 | 0.87471000E−4 |
| A8 | −0.20298000E−5 | −0.84011000E−5 |
| A10 | 0.45424000E−7 | 0.27300000E−6 |
| | 18th Surface | 19th Surface |
| ε | 1.0000 | 1.0000 |
| A4 | 0.91049000E−3 | −0.39049000E−3 |
| A6 | 0.30352000E−4 | −0.10716000E−5 |
| A8 | 0.81311000E−6 | −0.34427000E−6 |
| A10 | 0.92225000E−7 | −0.44351000E−7 |

| | 20th Surface |
|---|---|
| ε | 1.0000 |
| A4 | −0.28496000E−3 |
| A6 | 0.81096000E−5 |
| A8 | −0.21057000E−5 |
| A10 | 0.17445000E−7 |

TABLE 5

| | | | Focal Length | | | |
|---|---|---|---|---|---|---|
| | | | Condition | W | M | T |
| | | | f [mm] | 5.88 | 11.74 | 16.72 |
| Example 3 | | | FNO | 2.65 | 4.25 | 5.18 |
| i | ri [mm] | | di [mm] | Ni | νi | Element, etc. |
| 1 | 105.834 | | 0.900 | 1.69350 | 53.34 | GR1(−) |
| 2 | 8.476 | * | 2.520 | | | |
| 3 | ∞ | | 10.500 | 1.84666 | 23.78 | PR |
| 4 | ∞ | | 0.800 | | | |
| 5 | −43.559 | | 0.700 | 1.69680 | 55.46 | |
| 6 | 12.757 | | 0.010 | 1.51400 | 42.83 | |
| 7 | 12.757 | | 2.050 | 1.83400 | 37.34 | |
| 8 | −49.853 | | 13.669(W)˜8.226(M)˜2.000(T) | | | |
| 9 | ∞ | | 5.682(W)˜0.500(M)˜0.500(T) | | | SH |
| 10 | ∞ | | 0.000 | | | ST |
| 11 | 9.200 | | 1.409 | 1.72916 | 54.67 | GR2(+) |
| 12 | 17.974 | | 0.200 | | | |
| 13 | 10.464 | | 2.097 | 1.72916 | 54.67 | |
| 14 | 122.799 | | 0.010 | 1.51400 | 42.83 | |
| 15 | 122.799 | | 1.396 | 1.76182 | 26.61 | |
| 16 | 8.159 | | 1.324 | | | |
| 17 | −97.387 | * | 1.650 | 1.53048 | 55.72 | |
| 18 | −18.444 | * | 1.920(W)˜15.775(M)˜22.376(T) | | | |
| 19 | −14.134 | | 0.800 | 1.58144 | 40.89 | GR3(+) |
| 20 | 26.403 | | 0.100 | | | |
| 21 | 9.251 | * | 4.000 | 1.53048 | 55.72 | |
| 22 | −8.913 | * | 5.987(W)˜2.748(M)˜2.373(T) | | | |
| 23 | −37.760 | | 0.800 | 1.83400 | 37.34 | GR4(−) |
| 24 | ∞ | | 0.075 | | | |
| 25 | ∞ | | 1.280 | 1.54426 | 69.60 | PT |
| 26 | ∞ | | 0.940 | | | |
| 27 | ∞ | | 0.500 | 1.51680 | 64.20 | |
| 28 | ∞ | | 0.800 | | | |
| 29 | ∞ | | | | | IM(SR) |

TABLE 6
Example 3
Aspherical Surface Data of i-th Surface (*)

| | 2nd Surface | 17th Surface |
|---|---|---|
| ε | 1.0000 | 1.0000 |
| A4 | −0.10392000E−3 | −0.76610000E−3 |
| A6 | −0.53626000E−5 | 0.11199000E−4 |
| A8 | 0.30059000E−6 | −0.17535000E−6 |
| A10 | −0.10396000E−7 | 0.32599000E−7 |
| A12 | 0.12414000E−9 | |
| | 18th Surface | 21st Surface |
| ε | 1.0000 | 1.0000 |
| A4 | −0.24945000E−3 | −0.16742000E−3 |
| A6 | 0.10105000E−4 | −0.18958000E−4 |
| A8 | 0.80434000E−6 | 0.14388000E−5 |
| A10 | −0.48658000E−8 | −0.45729000E−7 |
| A12 | | 0.62920000E−9 |

| | 22nd Surface |
|---|---|
| ε | 1.0000 |
| A4 | 0.48204000E−3 |
| A6 | −0.11870000E−4 |
| A8 | 0.51961000E−6 |
| A10 | 0.24994000E−9 |
| A12 | −0.12903000E−9 |

TABLE 7

| | | | | Conditional |
|---|---|---|---|---|
| | Tw | Sw | St | Formula (1), (1a) |
| | (mm) | (mm) | (mm) | Sw/Tw |
| Example 1 | 22.032 | 6.923 | 0.500 | 0.314 |
| Example 2 | 11.147 | 4.031 | 0.500 | 0.362 |
| Example 3 | 19.351 | 5.682 | 0.500 | 0.294 |

1. An optical apparatus comprising:
a lens system including a plurality of lens units for forming an image on a predetermined focal plane, at least one of the lens units being movable along an optical axis, a focal length of the lens system being varied as a result of the at least one of the lens units being moved;
a shutter disposed to an object side of a most image-side lens unit of the plurality of lens units;
an aperture stop for determining an f-number,
wherein, as the at least one lens unit moves, at least within part of a movement range thereof, an interval between the shutter and the aperture stop varies.

2. An optical apparatus as claimed in claim 1,
wherein, during zooming, the shutter moves in such a way that a position thereof relative to the predetermined focal plane varies.

3. An optical apparatus as claimed in claim 1,
wherein there is in a zoom range a part within which the interval between the shutter and the aperture stop does not vary.

4. An optical apparatus as claimed in claim 1,
wherein the shutter is disposed within a lens-unit-to-lens-unit interval where is located a point at which a central ray of an off-axial beam that focuses at a highest image height crosses the optical axis.

5. An optical apparatus as claimed in claim 1,
wherein the shutter is disposed at or near a point at which a central ray of an off-axial beam that focuses at a highest image height crosses the optical axis.

6. An optical apparatus as claimed in claim 1,
wherein the aperture stop is disposed within a predetermined lens unit, the shutter is disposed between this lens unit and a lens unit adjacent on an object side thereto, and the following condition is fulfilled:
0.1<Sw/Tw<0.6 (1)
where
Sw is a distance between the shutter and the aperture stop at a wide-angle end, and
Tw is a lens-unit-to-lens-unit interval including the shutter at the wide-angle end.

7. An optical apparatus as claimed in claim 1,
wherein the following condition is fulfilled:
Sw>St (2)
where
Sw is a distance between the shutter and the aperture stop at a wide-angle end, and
St is a distance between the shutter and the aperture stop at a telephoto end.

8. An optical apparatus as claimed in claim 1,
wherein an aperture diameter of the aperture stop does not vary at least during exposure.

9. An optical apparatus as claimed in claim 1,
wherein the lens system comprises, from an object side, at least a first lens unit having a negative optical power and a second lens unit having a positive optical power, at least a distance between the first and second lens units being varied for zooming from a wide-angle end to a telephoto end, the shutter being disposed between the first and second lens units, the aperture stop being disposed within the second lens unit.

10. An optical apparatus as claimed in claim 1,
wherein the lens system comprises, from an object side, at least a first lens unit having a positive optical power, a second lens unit having a negative optical power, and a third lens unit, at least a distance between the second and third lens units being varied for zooming from a wide-angle end to a telephoto end, the shutter being disposed between the second and third lens units, the aperture stop being disposed within the third lens unit.

11. An optical apparatus as claimed in claim 1,
wherein the optical apparatus is a digital camera, and further comprises:
an image sensor, disposed on the predetermined focal plane, for converting the optical image formed on the predetermined focal plane by the lens system into an electrical signal.

12. An optical apparatus as claimed in claim 1,
wherein the optical apparatus is an image-sensing unit to be incorporated into a digital device, and further comprises:
an image sensor, disposed on the predetermined focal plane, for converting the optical image formed on the predetermined focal plane by the lens system into an electrical signal.

13. An optical apparatus as claimed in claim 1,
wherein the optical apparatus is a taking lens to be used in an image-taking apparatus.

14. An optical apparatus comprising:
a lens system including a plurality of lens units for forming an image on a predetermined focal plane, at least one of the lens units being movable along an optical axis, a focal length of the lens system being varied as a result of the at least one of the lens units being moved;
a shutter disposed to an object side of a most image-side lens unit of the plurality of lens units;
an aperture stop for determining an f-number,
wherein, as the at least one lens unit moves, at least within part of a movement range thereof, the shutter moves in such a way that the shutter is located at or near a point at which a central ray of an off-axial beam that focuses at a highest image height crosses the optical axis.

15. An optical apparatus as claimed in claim 14,
wherein the aperture stop is disposed within a predetermined lens unit, the shutter is disposed between this lens unit and a lens unit adjacent on an object side thereto, and the following condition is fulfilled:
0.1<Sw/Tw<0.6 (1)
where
Sw is a distance between the shutter and the aperture stop at a wide-angle end, and
Tw is a lens-unit-to-lens-unit interval including the shutter at the wide-angle end.

16. An optical apparatus as claimed in claim 14,
wherein the following condition is fulfilled:
Sw>St (2)
where
Sw is a distance between the shutter and the aperture stop at a wide-angle end, and
St is a distance between the shutter and the aperture stop at a telephoto end.

17. An optical apparatus as claimed in claim 14,
wherein an aperture diameter of the aperture stop does not vary at least during exposure.

18. An optical apparatus as claimed in claim 14,
wherein the lens system comprises, from an object side, at least a first lens unit having a negative optical power and a second lens unit having a positive optical power, at least a distance between the first and second lens units being varied for zooming from a wide-angle end to a telephoto end, the shutter being disposed between the first and second lens units, the aperture stop being disposed within the second lens unit.

19. An optical apparatus as claimed in claim 14,
wherein the lens system comprises, from an object side, at least a first lens unit having a positive optical power, a second lens unit having a negative optical power, and a third lens unit, at least a distance between the second and third lens units being varied for zooming from a wide-angle end to a telephoto end, the shutter being disposed between the second and third lens units, the aperture stop being disposed within the third lens unit.

20. An optical apparatus as claimed in claim 14,
wherein the optical apparatus is a digital camera, and further comprises:
an image sensor, disposed on the predetermined focal plane, for converting the optical image formed on the predetermined focal plane by the lens system into an electrical signal.

21. An optical apparatus as claimed in claim 14,
wherein the optical apparatus is an image-sensing unit to be incorporated into a digital device, and further comprises:
an image sensor, disposed on the predetermined focal plane, for converting the optical image formed on the predetermined focal plane by the lens system into an electrical signal.

22. An optical apparatus as claimed in claim 14,
wherein the optical apparatus is a taking lens to be used in an image-taking apparatus.
